(19) United States
(12) Patent Application Publication
(10) Pub. No.: US 2004/0252019 A1
(43) Pub. Date: Dec. 16, 2004

(54) Trailer eye

(76) Inventor: George Emil Paull, Sherwood Park (CA)

Correspondence Address: George Paull, 47 Catalina Dr., Sherwood Park AB., T8H 1T4, CA

(21) Appl. No.: 10/457,329

(22) Filed: Jun. 10, 2003

(51) Int. Cl. G08B 21/00

(52) U.S. Cl. 340/431; 340/686.2

(57) ABSTRACT

Most drivers experience the same problem when it comes to backing your vehicle up to your travel trailer or fifth wheel camper, you don't know when to stop or if the ball of the receiver is left or right of the trailer coupler. This is a difficult time-consuming task and often a second person is required to help creating a hazardous situation as that person has a tendency to stand between the vehicle and the trailer. If a second person is not available then the driver has to get out of his vehicle several times and readjust the position of the towing vehicle relative to the trailer. Property damage can also occur if the towing unit hits the towed unit.

The intent is to provide the driver of the vehicle a visual source to confirm the position of the vehicle relative to the trailer. With the use of a laser light source and fluorescent target the desired results can be achieved. The laser light source is visible under all lighting conditions.

### REFERENCES CITED

### U.S. Pat. Documents

| | | | |
|---|---|---|---|
| 4852901 | August, 1989 | Beasley et al. | 280/477. |
| 4938495 | July, 1990 | Beasley et al. | 340/431. |
| 4988116 | January, 1991 | Eversten | 280/477. |
| 5108123 | April, 1992 | Rubenzik | 280/477. |
| 5191328 | March, 1993 | Nelson | 340/870. |
| 5455557 | October, 1995 | Noll et al. | 340/431. |
| 5461471 | October, 1995 | Sommerfeld | 356/3. |
| 5513870 | May, 1996 | Hickman | 280/477. |
| 5729194 | March, 1998 | Spears et al. | 340/431. |
| 6,252,497 | June, 2001 | Dupay, et al. | 340/431. |

### BACKGROUND OF THE INVENTION

This invention is designed specifically as an aid to the driver of the towing unit to line up the coupler of a travel trailer to the ball of the receiver. Also to line up the kingpin of fifth wheel travel trailers to the fifth wheel of the towing unit.

The above mentioned towed units are recreational vehicles. Most owners of these types of units only couple their units a few times a year, which gives them very little practice. As a result the alignment process takes several attempts increasing the chances of damage to either the towed unit or the towing unit. The driver usually must exit their vehicle several times to see where their couplers and receivers are in relationship to each other. This whole process is very time consuming.

Known alignment systems use a variety of technologies to measure lateral offset and vertical alignment. U.S. Pat. No. 6252497 employ the use of laser technology and complex sensors that continually send signals back to a processing unit. Several references have been cited and contained within those patents are descriptions employing the use of magnetic switching devices, ultrasonic signals, complex mechanical cables tied to switches and matrixes of sensors. These devices employ complex technologies that are both time consuming and expensive to install.

Trailer Eye makes use of relatively inexpensive parts that already exist in the market. There are no sensors or processors involved, the whole process depends on visual contact only. The owner or user can quickly and easily install this invention. Lighting conditions do not affect the operation.

### SUMMARY OF THE INVENTION

The use of Trailer Eye will reduce the time to couple a towing unit with a towed unit as well as reduce the chances of damage to either unit.

It is an object of the present invention to provide a device for aiding the driver of the towing vehicle in properly positioning the receiver ball of the towing vehicle relative to the trailer coupler of the vehicle to be towed. It is another object of the present invention to provide a device which assists the driver of the towing vehicle in visualizing the relative positions of the receiver ball and trailer coupler without having to leave the driver's compartment of the towing vehicle.

It is still another object of the present invention to provide a device which permits the driver of the towing vehicle to properly position the receiver ball of the towing vehicle relative to the trailer coupler of the vehicle to be towed without requiring the assistance of a second person.

The above descriptions refer to two types of towed units, a standard travel trailer and a Fifth wheel style of travel trailer. The present invention can also be used for coupling utility trailers, boat trailers, horse trailers or any other vehicle/trailer combination. Therefore it is understood that the embodiment shown in the drawings and described above are merely for illustrative purposes and not intended to limit the scope of the invention.

### BRIEF DESCRIPTION OF THE SEVERAL VIEWS OF THE DRAWING:

Drawing # 1:Representative Drawing

Drawing # 2:Shows a simplified side view of a typical towing unit and towed unit, with the possible locations of the magnetic base and the fluorescent target.

Drawing # 3:Shows a simplified close up side view of the receiver with ball, coupler, bumper and magnetic base with laser pointer.

Drawing # 4:Shows two different locations the magnetic base can be mounted on the bumper.

Drawing # 5:Shows a top view of the line of sight. Laser light source to the fluorescent target.

Drawing # 6:Shows a simplified top view of the magnetic base with laser light source mounted on the receiver.

Drawing # 7:Shows a simplified side view of the magnetic base with laser light source if used with a Fifth Wheel style of trailer.

FIG. 12 Magnetic base

FIG. 13 Bumper of towing unit

FIG. 15 Receiver

FIG. 16 Fluorescent target

FIG. 17 Travel Trailer

FIG. 18 Coupler

FIG. 19 Laser pointer

FIG. 20 Support arm

FIG. 21 Adjustable clamp

FIG. 23 Ball of receiver

FIG. 24 Kingpin

FIG. 25 Fifth Wheel

### DETAILED DESCRIPTION OF THE INVENTION

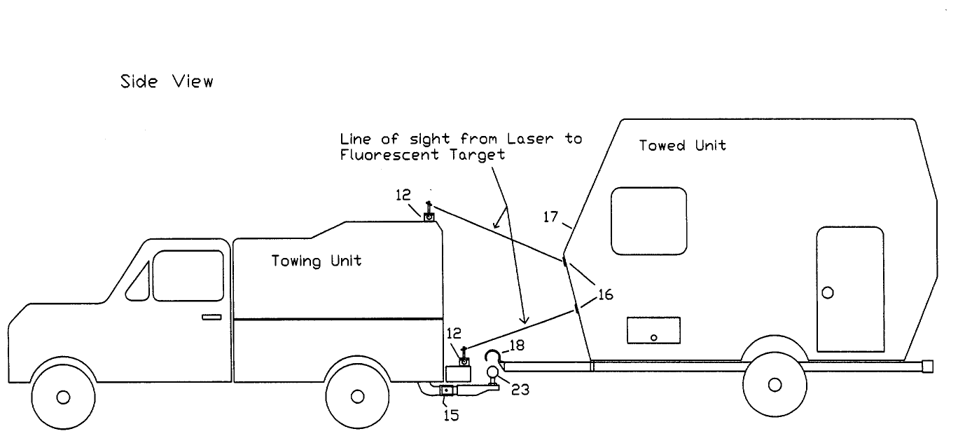

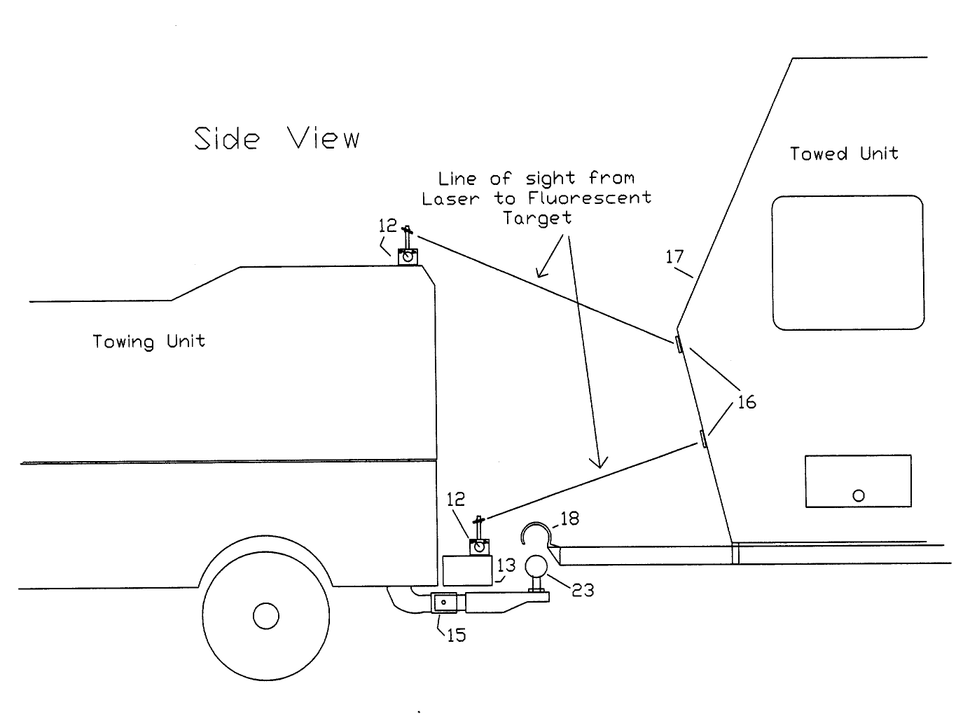

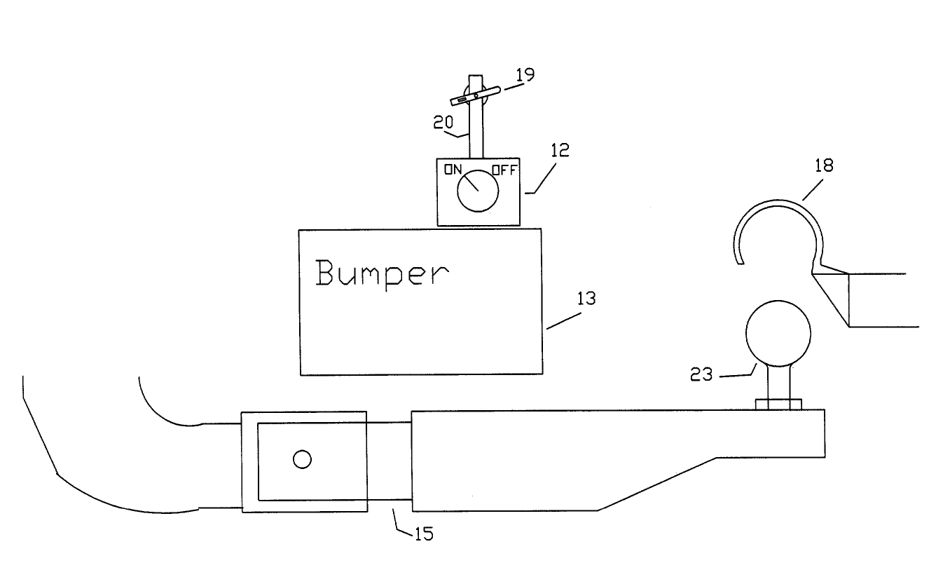

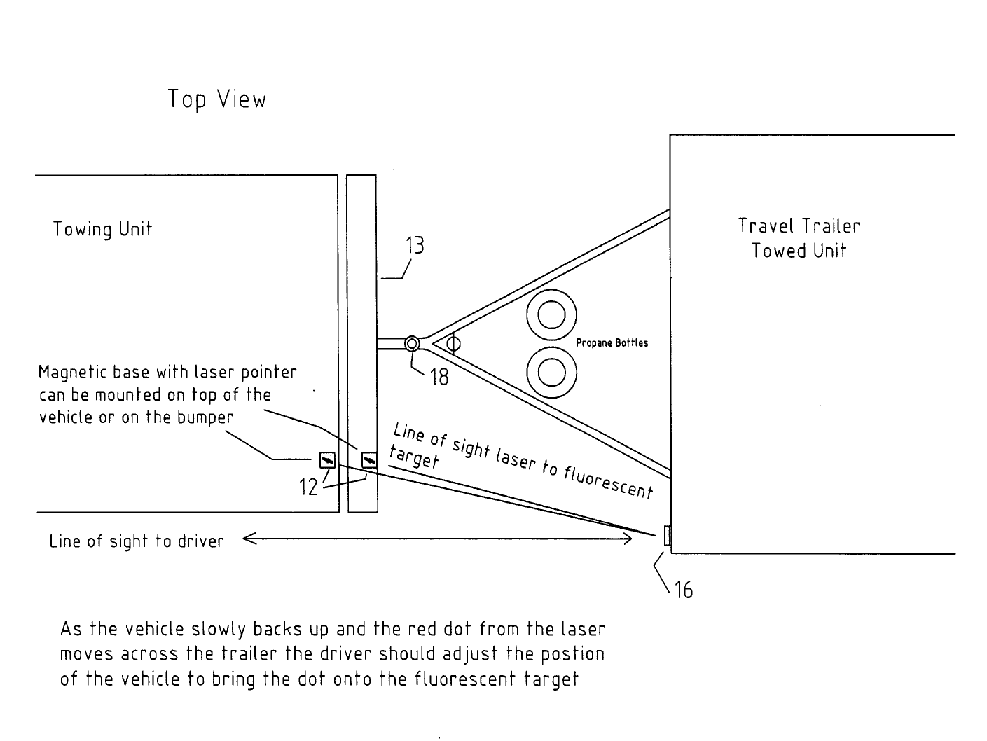

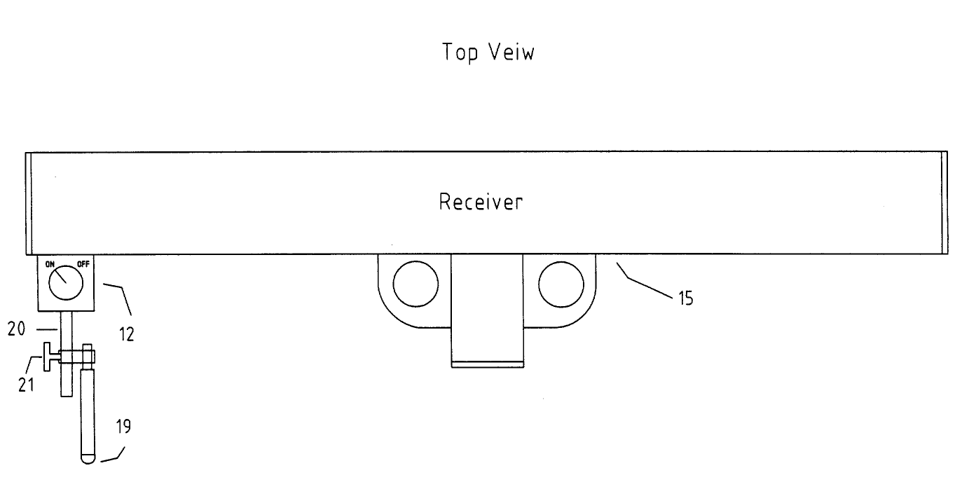

Several pieces have been assembled together to make a visual aid capable of guiding a towing unit to a towed unit. The parts consist of a magnetic base with an on off switch FIG. 12 on all drawings. Main support arm FIG. 20 drawings 3, 4 and 6. An adjustable clamp FIG. 21 drawing 6, that can be adjusted 360 degrees in any direction. A laser pointer FIG. 19 on drawings 3, 4 and 6. A one-inch diameter fluorescent target, FIG. 16 shown on drawings 2, 5 and 7. On drawing 2 the fluorescent target FIG. 16 is shown in two possible locations on the front of the towed unit FIG. 17. On drawing 2 the magnetic base with laser pointer is shown in two possible locations, the top of the towing unit or on the top of a metal bumper FIG. 13. The view shown on drawing 6 is of the receiver only. Normally it would be attached to a towing unit and hidden under the bumper.

The fluorescent target is only used as a guide position for the user to remember where the red dot from the laser pointer needs to stop. The location of the fluorescent target is normally about one foot from the driver side edge of the towed unit and about 2 feet from the bottom of the trailer. This position is visible from the mirror of the towing unit. The positions are entirely up to the user of the units and the visibility. Some users may prefer a position closer to the edge of the trailer others may prefer a position closer to the center if they can see the fluorescent target by looking over there shoulder. The only condition the owner must follow is that the magnetic base with laser pointer can not be lined up directly with the fluorescent target, an offset distance of one foot or greater above or below and left or right must be maintained.

The magnetic base will be mounted on steel or iron, body panels are not recommended, as the metal is very thin. The best locations are the receiver FIG. 15 drawing 6 or the bumper of the towing unit FIG. 13 drawings 2, 3 and 4.

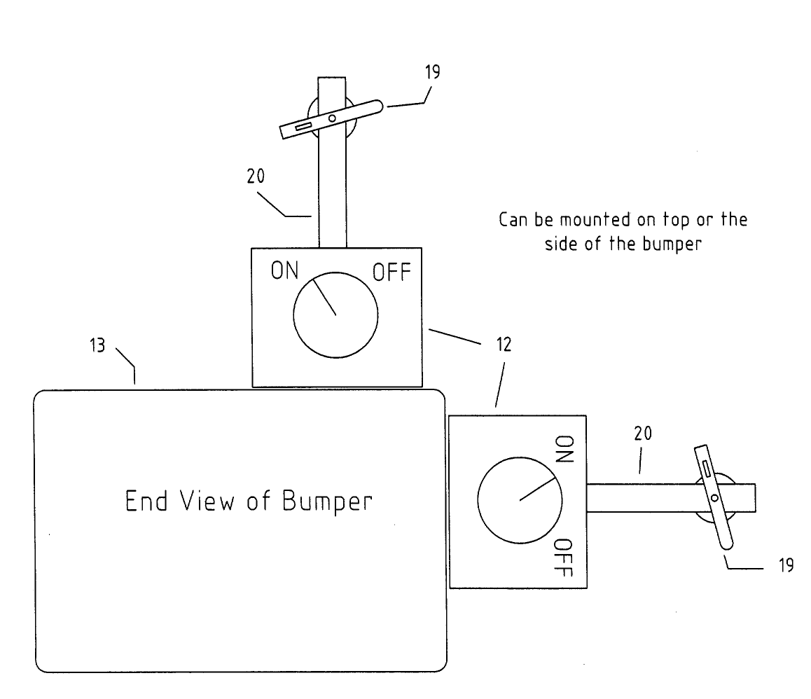

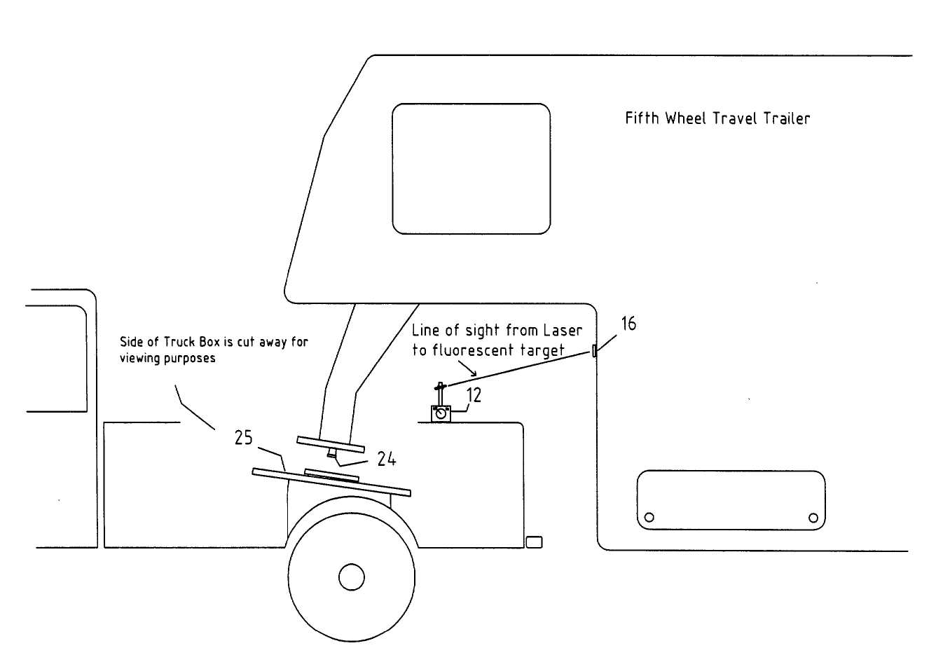

The initial setup requires the towing unit and the towed unit to be aligned, but not coupled. The towed unit is set at a level position with the coupler FIG. 18 directly above the ball FIG. 23 of the receiver drawings 2 and 3. The kingpin FIG. 24 directly above the fifth wheel FIG. 25 as shown in drawing 7. The laser pointer is then turned on and adjusted so the laser beam is pointed directly at the fluorescent target. The adjustable clamp FIG. 21 shown on drawing 6 is then tightened securely. The person doing the setup should then make note of the exact location of the magnetic base. The laser light and magnetic base are then turned off and placed in its protective case.

If the towed unit has been moved to a different location, before driving away leaving the towed unit behind the laser eye should be realigned then placed back in its case. The alignment process at this stage takes less than one minute.

After an initial setup has been completed but before coupling the units the driver mounts the magnetic base in the exact location as the setup, turns on the laser light source then proceeds to back towards the towed unit. When the towing unit is about 10 feet away from the towed unit the laser light dot will be visible somewhere on the towed unit. The driver then makes the necessary adjustments to slowly bring the red dot from the laser light source onto the target. Once achieved the driver shuts off the vehicle and proceeds with the coupling.

What I claim as my invention is:

1. An alignment system for coupling a towed unit to a towing unit comprised of a laser diode light source attached to an arm that is adjustable 360 degrees any direction, which in turn is attached to a main support arm that is attached to a magnetic base. The laser light source is then switched on to project a visible dot onto a fluorescent target. The visible light does not transmit any electronic signals nor does the target receive or emit any electronic signals.

2. Initial setup of alignment will be done with the towed unit and the towing unit aligned, the coupler of the towed unit will be directly above the ball of the receiver on the towing unit. In the case of a fifth wheel travel trailer the kingpin will be aligned directly above the connection point of the fifth wheel of the towing unit.

3. The base will be attached to the towing vehicle. The fluorescent target will be attached to the trailer.

4. The fluorescent target will be mounted on the front of the travel trailer or 5^{th} wheel travel trailer, in a location visible by the driver of the vehicle.

5. The magnetic base has an on off switch and can only be attached to metal. (Iron or steel).

6. The magnetic base can be attached to several locations, the bumper, the receiver, top of the towing unit (edge of the truck box), or the top of an SUV.

7. SUV's and like vehicles may have plastic bumpers. Therefore placing the magnetic base with adjustable laser pointer on the top of the towing unit or the front side of the receiver is recommended.

8. The power of the laser diode according to claim 1 will be between 600 nm and 750 nm, at a max output of <1.0 mW.

9. The visible source according to claim 1 will be a red dot of about one inch diameter at 15 feet.

10. The fluorescent target according to claim 1 is for the user to remember the location of the laser dot during setup. The fluorescent target is to be attached to the trailer.

11. The user then attaches the magnetic base according to claim 6. This is usually adjacent to the edge of a piece of trim or molding to aid in remembering the location.

12. The user should mark where the base was attached or make a mental note.

13. The laser dot is visible under any lighting conditions.

14. The surface area of a fluorescent target will be 1 inch diameter or smaller for accuracy purposes.

15. There are no electrically generated signals the full function is visual only.

16. The laser light source will be visible from any direction depending on how close the user is to the trailer and which angle the user backs up to the trailer.

17. As an example according to claim 12 if the laser source is higher than the target the visible laser dot will start from the lower half and progress upwards towards the target area as the user brings the vehicle closer to the trailer.

18. The laser pointer according to claim 1, adjustment is three-dimensional, 360 degrees any direction.
